(19) United States
(12) Patent Application Publication
(10) Pub. No.: US 2016/0310869 A1
(43) Pub. Date: Oct. 27, 2016

(54) APPARATUS AND METHODS FOR COOLING SAMPLES

(71) Applicant: Waters Technologies Corporation, Milford, MA (US)

(72) Inventors: Joseph A. Kareh, Westwood, MA (US); David Alden Piper, Leominster, MA (US)

(21) Appl. No.: 15/197,043

(22) Filed: Jun. 29, 2016

Related U.S. Application Data
(62) Division of application No. 12/160,621, filed on Aug. 20, 2008, now abandoned.
(60) Provisional application No. 60/759,636, filed on Jan. 18, 2006.

(51) Int. Cl. B01D 15/16; F28D 1/047; F28D 7/08; G01N 30/30; F28F 1/14

(52) U.S. Cl. CPC B01D 15/161; G01N 30/30; F28F 1/14; F28D 7/08; F28D 1/0477; G01N 2030/3038; F28D 2021/0077

(57) ABSTRACT

Embodiments of the present invention are directed to apparatus and methods for performing separations of compounds held in a solution. Embodiments of the present invention allow detectors to operate at constant reproducible temperatures that are lower than the temperature of fluids exiting separation devices. An apparatus of the present invention has pump means, fluid conveying means, sample injection means, separation means and heat dissipation means. The heat dissipation means is in fluid communication with the separation means for receiving the fluid and removing thermal energy.

### CROSS REFERENCE TO RELATED APPLICATIONS

This application claims benefit of priority and is a continuation of U.S. Provisional Application No. 60/759,636 filed Jan. 18, 2006. The contents of these applications are expressly incorporated herein by reference in its entirety.

### FIELD OF THE INVENTION

This invention relates to the field of chromatography.

### BACKGROUND OF THE INVENTION

A chromatographic separation is the separation of compounds from each other based on the different affinity the compounds have to a stationary phase. Solutions carrying the compounds move through the stationary phase causing the compounds to separate. High performance liquid chromatography is performed with a liquid as the mobile phase. The liquid is forced through a immobile solid phase comprising a bed of particles or matrix or monolithic porous structures or the walls of vessels in which the mobile phase flows. Chromatographic separations are performed with liquids, gases and supercritical fluids. This application will use the term “fluids” to means all such liquids, gases and supercritical fluids.

The term “chromatographic system” will be used herein to describe an instrument or combination of instruments that perform chemical separations. These systems often comprise detectors which produce a signal in response to a change in the fluid or presence of a compound. For example, if the fluid has a change in concentration of a particular compound, the response to light entering the fluid at a certain wavelength may change.

The detector may take different forms. Common detectors include optical sensors, mass sensors and electron spin detectors and the like. One form of mass detector is a mass spectrometer. Mass spectrometers operate under vacuum.

A typical chromatographic system comprises a pump, a sample injection device, a separation device, fluid conveying means and a detector. The pump is in communication with a source of fluid and propels the fluid through the fluid conveying means into a separation device and detector. The sample injector places a sample into the stream which flows to the separation device. The separation device separates the compounds held in solution in the fluid and discharges the separated compounds into fluid conveying means to the detector.

As used herein, the term “fluid conveying means” refers to conduits, pipes, capillaries, tubes and the like.

The separation device for many chromatographic processes comprises a porous monolith or plug, or a packing of particles, fibers, or nanotubes. The monolith, particles, fibers and nanotubes can be made of any substantially inert material from. Common materials comprise silica, carbon in the form of polymers, graphite and diamond, zirconium, aluminum. These materials may be further functionalized with chemical groups which impart special characteristics. The monolith, particles, fibers and nanotubes are contained in a column or cartridge equipped with fitting for attachment to the system fluidic components. The fluid is forced through these stationary phases under pressure. The flow of fluid through the monolith and/or packing generates substantial heat. This heat is normally carried downstream to the detector directly or through the conduits.

Some detectors and conduit materials may be sensitive to the heat of fluids they receive. It is desirable to operate detectors at constant reproducible temperatures and to limit the effect of high temperature on sensitive conduit materials.

### SUMMARY OF THE INVENTION

Embodiments of the present invention are directed to apparatus and methods for performing separations of compounds held in a solution. Embodiments of the present invention allow detectors to operate at constant reproducible temperatures that are lower than the temperature of fluids exiting separation devices. Turning first to the apparatus, one apparatus of the present invention has pump means, fluid conveying means, sample injection means, separation means and heat dissipation means.

The pump means is for propelling a fluid and can take many forms known in the art. Common chromatography pumps are serial or parallel syringe pumps sold. Other pumps that are less common comprise electrokinetic pumps, centrifugal pumps, turbine pumps and the like.

Fluid conveying means is in fluid communication with the pump means for receiving a fluid. The fluid conveying means comprises pipes, tubing, capillaries, conduits and the like, with normal fittings, “T” connectors, unions and couplers known in the art.

Sample injection means is in communication with the fluid conveying means for placing a sample in said fluid. Sample injection means may take several forms as well. Typical sample injection means known in the art include autosamplers, sample injection loops, ports and sample valves.

Separation means is in communication with the fluid conveying means downstream of the sample injection means. The separation means comprising a stationary phase through which the fluid flows and generates heat. The fluid has a post separation exiting temperature higher than ambient as a result of the heat generated in the separation means. The separation means is a column or cartridge having a porous monolithic matrix, or a packing of particles, fibers or nanotubes. This application will use the term “column” and cartridge interchangeably. For some purposes, it is desirable to heat the column. Thermostat controlled column ovens or heaters are used which further increase the thermal energy of fluids exiting the column.

The heat dissipation means is in fluid communication with the separation means for receiving the fluid and removing thermal energy. The fluid has a post cooling temperature leaving the heat dissipation means at least twenty degrees centigrade less than the post separation exiting temperature.

One embodiment of the present invention features heat dissipation means in the form of a tubing having one or more cooling loops. A further embodiment of heat dissipation means is a tubing having one or more cooling fins.

A further embodiment of the present invention features a heat dissipation means in the form of a thermal cooling block. A preferred thermal cooling block has cooling fins.

A preferred heat dissipation means is placed in an air stream. The air stream is preferably generated by one or more fans. Common chromatography equipment has one or more heat generating components and a centralized fan for generating an air stream for cooling said heat generating component. A preferred embodiment of the present invention features an air stream generated by a centralized fan cooling one or more components and the heat dissipation means.

A further embodiment of the present invention is directed to a method of controlling the temperature of fluids flowing from a separation means. Fluids leaving the separation means have a post separation exiting temperature. The method comprises the step of providing heat dissipation means in fluid communication with the separation means. The heat dissipation means receives the fluid and removes thermal energy. The fluid has a post cooling temperature at least twenty degrees centigrade less than said post separation exiting temperature.

A preferred method uses heat dissipation means in the form of a tubing having one or more cooling loops, or tubing having one or more cooling fins or a thermal cooling block or thermal cooling block having one or more cooling fins.

A preferred heat dissipation means is placed in an air stream. The air stream may be generated by air currents in the surrounding environment of the device or generated by one or more fans. A preferred method uses a centralized fan used for cooling one or more heat generating components

These and other features and advantages will be apparent to individuals skilled in the art upon viewing the drawing and reading the detailed description that follow.

### BRIEF DESCRIPTION OF THE DRAWINGS

FIG. 1 is a schematic representation of an apparatus embodying features of the present invention;

FIG. 2 is a view of an apparatus embodying features of the present invention;

FIG. 3 is a view of an apparatus embodying features of the present invention; and,

FIG. 4 is a view of an apparatus embodying features of the present invention.

### DETAILED DESCRIPTION OF THE INVENTION

Embodiments of the present invention will be described in detail with respect to apparatus and methods for performing separations of compounds held in a solution. However, embodiments of the present invention have broader application and have utility where it is desired to operate at constant reproducible temperatures that are lower than the temperature of fluids exiting an upstream component that adds thermal energy. This discussion is directed to the preferred embodiments of the present invention and should not be considered limiting.

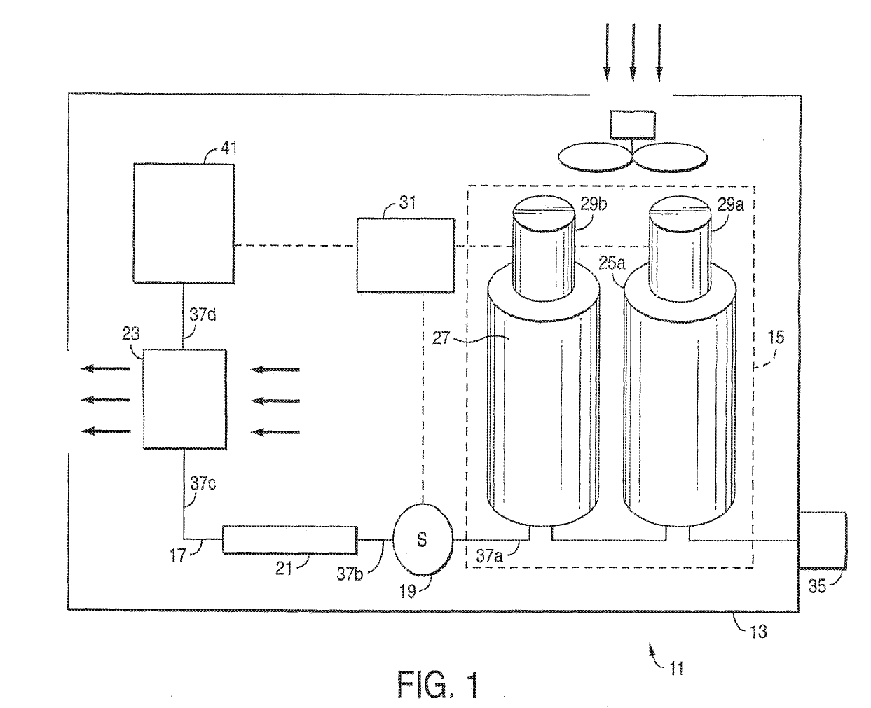

Referring now to FIG. 1, an apparatus, for performing separations of compounds, generally designated by the numeral 11, is depicted. The apparatus 11 is contained in a housing 13. The housing 13 contains the major components of apparatus 11 comprising pump means 15, fluid conveying means 17, sample injection means 19, separation means 21 and heat dissipation means 23.

The pump means 15 is depicted with a dotted block. The pump means 15 is for propelling a fluid and can take many forms known in the art. As previously noted, common chromatography pumps include serial and parallel syringe pumps. Such pumps are sold by a variety of vendors including Waters Corporation (Milford Mass., USA) under the trademarks ACQUITY™ and ALLIANCE® and Agilent Corporation, (Palo Alto. Calif., USA), Hitachi Corporation Japan, Shimadzu Corporation Japan. Other pumps that are less common comprise electrokinetic pumps, centrifugal pumps, turbine pumps and the like.

Pump means 15, as depicted is a serial pump having a primary pump 25 and a secondary pump 27. The primary pump 25 is powered by a primary pump motor 29a and the secondary pump 27 is powered by a secondary pump motor 29b. The operation and control of the pump means 15 is known in the art.

As depicted, a pump control means 31 is in signal communication with the pump means 15. As used herein, “signal communication” refers electronic control through wires or wireless communication systems. The control means 31 is a computer processing unit (CPU), personal computer, server or mainframe computer [not shown]. The control means is programmed with firmware or software and can be incorporated in the housing 13 or maintained separately.

The pump means 15 is in fluid communication with a fluid reservoir 35. As used herein the term “fluid communication” means plumbed together. Fluid reservoir 35 is normally one or more solvent bottles [not shown].

Fluid conveying means 17 is in fluid communication with the pump means 15 for receiving a fluid. The fluid conveying means 17 comprises pipes, tubing, capillaries, conduits and the like, with normal fittings, “T” connectors, unions and couplers known in the art. A typical tubing size has an internal diameter of 0.004 inches although larger and smaller dimensions are also used. The tubing is made of an inert material, such as, by way of example, without limitation, stainless steel, PEEK, and fused silica. As depicted, fluid conveying means 17 has a first segment 37a, a second segment 37b, a third segment 37c.

Sample injection means 19 is in fluid communication with the fluid conveying means 17 for placing a sample in fluids. Sample injection means 19 known in the art include autosamplers, sample injection loops, ports and sample valves. As depicted, sample means 19 is in signal communication with the control means 31.

Separation means 21 is in communication with the fluid conveying means 17 downstream of the sample injection means 19. The separation means 21 is coupled to the second segment 37b of fluid conveying means 17. The separation means 21 has a stationary phase [not shown] through which the fluid flows and generates heat. Common stationary phases comprise porous monolithic matrixes, or a packing of particles, fibers or nanotubes [not shown]. The stationary phase is held in a column or cartridge. Columns and cartridges are available from several venders and sold under a variety of trademarks. By way of example, columns are available from Waters Corporation under the trademarks OASIS®, EXTERRA® and others.

The fluid exiting the separation means 21 has a post separation exiting temperature higher than ambient as a result of the heat generated in the separation means. This post separation temperature can exceed 60 degrees Celsius. It is common for such temperature to reach 90 degrees and higher.

The heat dissipation means 23 is in fluid communication with the separation means 21 through the third segment 37c of fluid conveying means 17. The heat dissipation means 23 receives the fluid from the separation means 21 and removes thermal energy. Thus the fluid exiting the heat dissipation means 23 has a post cooling temperature at least twenty degrees centigrade less than the post separation exiting temperature.

As depicted, fluid conveying means 17 has a fourth segment 37d in fluid communication with a detector 41. The detector 41 is selected from the group of detectors comprising optical sensors, mass sensors and electron spin detectors and the like. It is common to have the detector in signal communication with the control means 31 as illustrated by dotted lines.

The heat dissipation means 23 allow the downstream detectors 41 receive fluids which have a reproducible lower temperature. Signals produced by the detectors 41 are more reproducible and are less susceptible to drift.

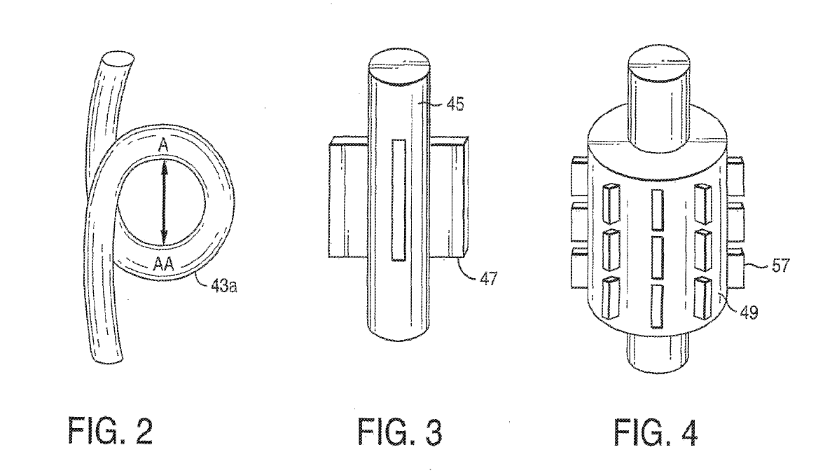

Turning now to FIG. 2, one embodiment of the present invention features heat dissipation means 23 in the form of a tubing 43a having one or more cooling loops. The loops of tubing 43 are made of an inert material, such as stainless steel, PEEK or fused silica and for typical chromatographic applications have a internal diameter of 0.004 inches. The loops are 1 to 5 centimeters in diameter denoted by line “A” and are preferably spaced to allow air circulation. A preferred heat dissipation means 23 has two to three loops with a diameter of approximately 1-3 centimeters. The total length of the tubing is between 3 to 20 centimeters.

Turning now to FIG. 3, a further embodiment of heat dissipation 23 means is a tubing 45 having one or more cooling fins 47. The a limited number of fins 47 are depicted in order to simplify the drawings. The tubing 45 is made of an inert material, such as stainless steel, PEEK or fused silica and for typical chromatographic applications have a internal diameter of less than about 0.004 inches.

Turning next to FIG. 4, a further embodiment of the present invention features a heat dissipation means 21 in the form of a thermal cooling block 49. A preferred thermal cooling block 49 has cooling fins 51. A limited number of fins 51 are depicted to simplify the drawings.

Returning now to FIG. 1, heat dissipation means 23 is placed in an air stream. The air stream is preferably generated by one or more fans 61. Common chromatography equipment has one or more heat generating components and a centralized fan for generating an air stream for cooling said heat generating component. A preferred embodiment of the present invention features an air stream generated by a centralized fan 61 cooling one or more components and the heat dissipation means. The air stream preferably is one half to five meters per second.

Embodiments of the present method will be described with respect to the operation of the present device. The method is directed to controlling the temperature of fluids flowing from a separation means 21. Fluids leaving the separation means 21 have a post separation exiting temperature. The method comprises the step of providing heat dissipation means 23 in fluid communication with the separation means 21. The heat dissipation means 23 receives the fluid and removes thermal energy. The fluid has a post cooling temperature at least twenty degrees centigrade less than said post separation exiting temperature.

A device 11, operating at fluid flow rates of 0.25 to 5 mililiters per minute, will exhibit post separation temperature of approximately 70 degrees Celsius when in a typical operation. The temperature of the fluid leaving a heat dissipation means 23 comprising a tubing 43a having two loops as depicted in FIG. 2, with a total length of 18 to 45.0 centimeters is 25 to 50 degrees Celsius and, most preferably, at least twenty degrees lower than the post separation temperature.

Thus, we have described the preferred embodiment of the invention and how to make and use it with the understanding that the invention may be modified and altered without departing from the teaching. Therefore, the present invention should not be limited to the precise details of the preceding description but should encompass the subject matter of the following claims and their equivalents.

We claim:

1. A device for performing separations of compounds held in a solution comprising:
a. pump means for propelling a fluid;
b. fluid conveying means in fluid communication with said pump means for receiving a fluid;
c. sample injection means in communication with said fluid conveying means for placing a sample in said fluid;
d. separation, means in communication with said fluid conveying means downstream of said sample injection means, said separation means comprising a stationary phase through which said fluid flows and generates heat said fluid having a post separation exiting temperature higher than ambient;
e. heat dissipation means in fluid communication with said separation means for receiving said fluid and removing thermal energy, said fluid having a post cooling temperature at least twenty degrees centigrade less than said post separation exiting temperature.

2. The device of claim 1 wherein said heat dissipation means is a tubing having one or more cooling loops.

3. The device of claim 1 wherein said heat dissipation means is a tubing having one or more cooling fins.

4. The device of claim 1 wherein said heat dissipation means is a thermal cooling block.

5. The device of claim 4 wherein said thermal cooling block has cooling fins.

6. The device of claim 1 wherein said heat dissipation means is placed in an air stream.

7. The device of claim 6 wherein said air stream is generated by one or more fans.

8. The device of claim 1 further comprising one or more heat generating components and a centralized fan for generating an air stream for cooling said heat generating component and said heat dissipation means.

9. A method of controlling the temperature of fluids flowing from a separation means comprising the step of providing heat dissipation means, said heat dissipation means in fluid communication with said separation means for receiving said fluid and removing thermal energy, said fluid having a post cooling temperature at least twenty degrees centigrade less than said post separation exiting temperature.

10. The method of claim 9 wherein said heat dissipation means is a tubing having one or more cooling loops.

11. The method of claim 9 wherein said heat dissipation means is a tubing having one or more cooling fins.

12. The method of claim 9 wherein said heat dissipation means is a thermal cooling block.

13. The method of claim 12 wherein said thermal cooling block has cooling fins.

14. The method of claim 9 wherein said heat dissipation means is placed in an air stream.

15. The method of claim 14 wherein said air stream is generated by one or more fans.

16. The method of claim 9 further comprising one or more heat generating components and a centralized fan for generating an air stream for cooling said heat generating component and said heat dissipation means.
